(19) United States
(12) Patent Application Publication
(10) Pub. No.: US 2004/0186947 A1
(43) Pub. Date: Sep. 23, 2004

(54) Access control system for nonvolatile memory

(75) Inventors: Taichi Nagata, Osaka (JP); Yusuke Nemoto, Hyogo (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/799,609

(22) Filed: Mar. 15, 2004

(30) Foreign Application Priority Data
Mar. 19, 2003 (JP) 2003-075714

(51) Int. Cl. G06F 12/00

(52) U.S. Cl. 711/103; 711/163

(57) ABSTRACT

A CPU (Central Processing Unit) sets an unrewritable area in a nonvolatile memory in accordance with a program for system initialization stored in a boot ROM (Read Only Memory). An access control circuit controls permission/prohibition of rewriting based on a written flag set in the unrewritable area. This allows a system creator to freely write information which needs protection against tampering and also ensures protection against tampering of the information.

### BACKGROUND OF THE INVENTION

The present invention relates to access control systems for nonvolatile memories.

According to a prior art technique, a write frequency limiting circuit for limiting the number of write operation at a specific address is provided to a nonvolatile memory for storing information such as accounting information and balance information so as to prevent illegitimate use of IC cards (see Japanese Laid-Open Publication No. 8-329208).

According to another prior art technique, the rewriting of data is allowed only in a predetermined address area but is prohibited using hardware in the other address area for storing programs (see Japanese Laid-Open Publication No. 11-110287).

For example, in the case of receiving chargeable contents such as music and movies on, for example, a cellular phone, authentication information such as a user ID or a password is required. In addition, key information is also needed to decrypt encrypted contents. In the case of using such information by storing it in a nonvolatile memory, it is important to take security measurements against tempering of the information.

However, in the prior art technique with which the write frequency limiting circuit to the specific address is provided to the nonvolatile memory, rewriting might become impossible if a system creator fails to write information which needs protection against tampering.

### SUMMARY OF THE INVENTION

It is therefore an object of the present invention to provide an access control system for a nonvolatile memory that allows a system creator to freely write information which requires protection against tampering and that ensures protection against tempering.

In order to achieve this object, according to the present invention, a CPU (Central Processing Unit) sets an unrewritable area in a nonvolatile memory in accordance with a program for system initialization stored in a boot ROM (Read Only Memory), and an access control circuit controls permission/prohibition of rewriting in accordance with a written flag set in the unrewritable area.

Specifically, the present invention adopts a configuration including: a nonvolatile memory; a boot ROM in which a program for initializing the system is stored; a CPU for issuing a command to the nonvolatile memory; and an access control circuit for receiving the command from the CPU and controlling access to the nonvolatile memory. At every power-on of the system, the CPU executes the program for initializing the system stored in the boot ROM so that an unrewritable area is set at only one time in the nonvolatile memory and a written flag is set at only one time in the unrewritable area. The access control circuit prohibits writing to the nonvolatile memory before checking the state of the written flag and, after checking the state of the written flag, the access control circuit permits writing to the unrewritable area at any number of times as long as the written flag does not indicate prohibition of rewriting, while prohibiting writing to the unrewritable area after prohibition of rewriting has been set in the written flag.

### BRIEF DESCRIPTION OF THE DRAWINGS

FIG. 1 is a block diagram showing an example of an entire access control system for a nonvolatile memory according to the present invention.

FIG. 2 is a diagram showing an inside configuration of the nonvolatile memory shown in FIG. 1.

FIG. 3 is a diagram showing an inside configuration of the access control circuit shown in FIG. 1.

FIG. 4 is a state transition diagram showing operation of a register state machine shown in FIG. 3.

FIG. 5 is a table showing examples of commands to the nonvolatile memory shown in FIG. 1.

FIG. 6 is a state transition diagram showing operation of a command analyzing section shown in FIG. 3.

FIG. 7 is a diagram showing another inside configuration of the nonvolatile memory shown in FIG. 1.

FIG. 8 is a diagram showing an inside configuration of the command analyzing section shown in FIG. 3.

FIG. 9 is a diagram showing another inside configuration of the command analyzing section shown in FIG. 3.

### DESCRIPTION OF THE PREFERRED EMBODIMENTS

Hereinafter, an embodiment of the present invention will be described in detail with reference to the accompanied drawings.

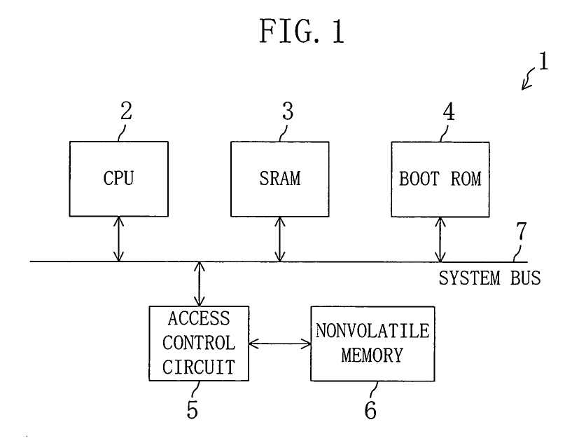

FIG. 1 shows an example of the entire configuration of an access control system for a nonvolatile memory according to the present invention. In the access control system 1 for a nonvolatile memory shown in FIG. 1, reference numeral 2 denotes a CPU, reference numeral 3 denotes an SRAM (Static Random Access Memory), reference numeral 4 denotes a boot ROM, reference numeral 5 denotes an access control circuit, reference numeral 6 denotes a nonvolatile memory and reference numeral 7 denotes a system bus. The CPU 2, the SRAM 3 and the boot ROM 4 are connected to the system bus 7. The access control circuit 5 is interposed between the nonvolatile memory 6 and the system bus 7. The SRAM 3 is a memory for storing a program or data therein. The boot ROM 4 is a memory in which a program for initializing the system is stored. The nonvolatile memory 6 is, for example, a flash memory. The CPU 2 executes the program stored in the SRAM 3 or the program stored in the boot ROM 4, thereby issuing a command for access to the nonvolatile memory 6. The access control circuit 5 is a circuit for receiving the command from the CPU 2 and controlling the access to the nonvolatile memory 6.

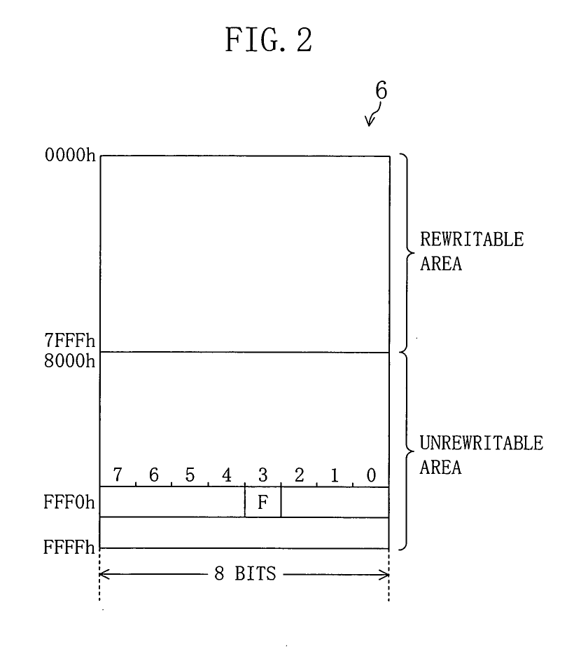

FIG. 2 shows an inside configuration of the nonvolatile memory 6 shown in FIG. 1. The nonvolatile memory 6 is divided into a rewritable area from address 0000h to address 7FFFh and an unrewritable area from address 8000h to address FFFFh, for example, (where h is a number in hexadecimal notation: the same hereinafter). A written flag F of one bit is set in one byte specified by, for example, address FFF0h in the unrewritable area. Hereinafter, it is assumed that all the bits are “1” while the nonvolatile memory 6 is in an initialized state. Accordingly, the initial value of the written flag F is also “1”. It is herein also assumed that “F=1” represents permission for rewriting and “F=0” represents prohibition of rewriting.

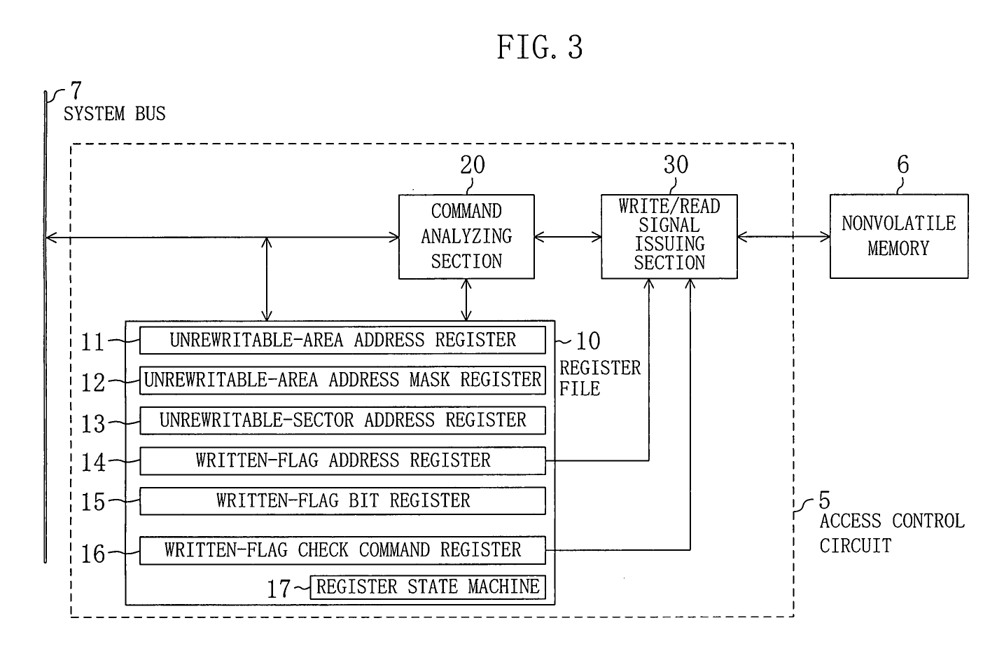

FIG. 3 shows an inside configuration of the access control circuit 5 shown in FIG. 1. The access control circuit 5 shown in FIG. 3 includes: a register file 10; a command analyzing section 20; and a write/read signal issuing section 30. The register file 10 includes: an unrewritable-area address register 11; an unrewritable-area address mask register 12; an unrewritable-sector address register 13; a written-flag address register 14; a written-flag bit register 15; a written-flag check command register 16; and a register state machine 17. The command analyzing section 20 analyzes the command received from the CPU 2 via the system bus 7 with reference to the register file 10. The write/read signal issuing section 30 issues a signal for write/read/erase operation to the nonvolatile memory 6 in accordance with the analysis result of the command analyzing section 20. In particular, in the case of access to one byte containing the written flag F in the nonvolatile memory 6, the write/read signal issuing section 30 refers to the written-flag address register 14 and the written-flag check command register 16.

At every power-on of the system, the CPU 2 shown in FIG. 1 executes the program for system initialization stored in the boot ROM 4 so that an unrewritable area is set at only one time in the nonvolatile memory 6 and a written flag F is set at only one time in the unrewritable area. According to the example shown in FIG. 2, 8000h and 7FFFh are set in the unrewritable-area address register 11 and the unrewritable-area address mask register 12, respectively. In addition, FFF0h and 3h are set in the written-flag address register 14 and the written-flag bit register 15, respectively.

The access control circuit 5 shown in FIG. 3 prohibits any writing to the nonvolatile memory 6 until the access control circuit 5 receives a written-flag check command from the CPU 2 and checks the state of the written flag F. After checking the state of the written flag F, the access control circuit 5 permits writing to the unrewritable area at any number of times as long as the written flag F indicates permission for rewriting (F=1), while prohibiting any writing to the unrewritable area after prohibition of rewriting (F=0) has been set in the written flag F. This allows a system creator to freely write information which needs protection against tampering, and also ensures protection against tampering of the information.

The command analyzing section 20 shown in FIG. 3 operates such that the command received from the CPU 2 is not transmitted to the write/read signal issuing section 30 if the command received from the CPU 2 indicates writing or erasing to the nonvolatile memory 6, the writing or erasing is directed to the unrewritable area in the nonvolatile memory 6 and the written flag F indicates prohibition of rewriting (F=0).

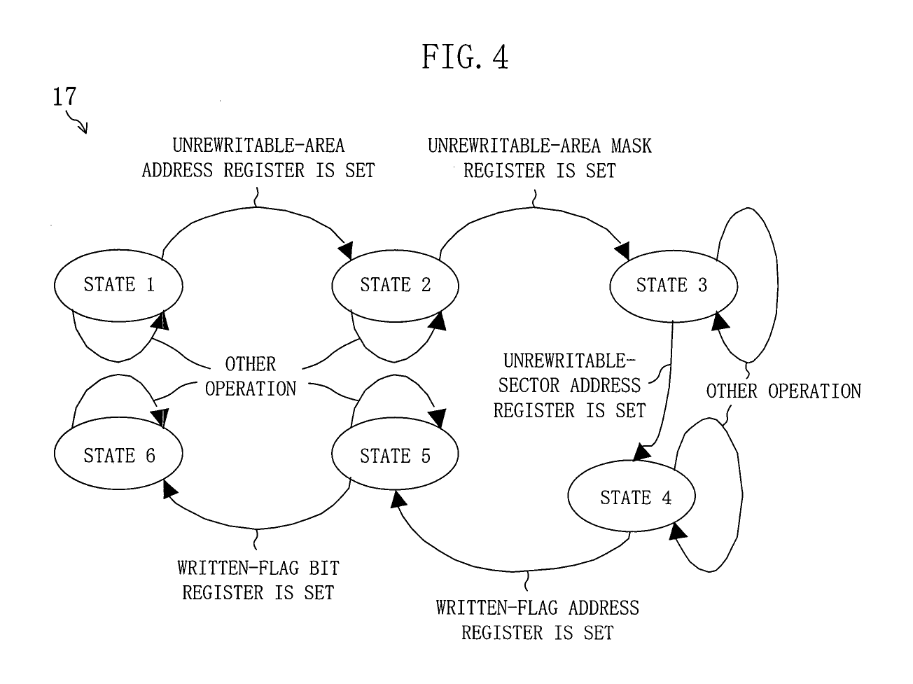

FIG. 4 shows operation of the register state machine 17 shown in FIG. 3. The register state machine 17 is in a state 1 as an initial state. If the unrewritable-area address register 11 is set by the CPU 2 in the state 1, the register state machine 17 transitions to a state 2. If the unrewritable-area address register 11 is not set, the register state machine 17 remains in the state 1. If the unrewritable-area address mask register 12 is set in the state 2, the register state machine 17 transitions to a state 3. If the unrewritable-area address mask register 12 is not set, the register state machine 17 remains in the state 2. If the unrewritable-sector address register 13 is set in the state 3, the register state machine 17 transitions to a state 4. If the unrewritable-sector address register 13 is not set, the register state machine 17 remains in the state 3. If the written-flag address register 14 is set in the state 4, the register state machine 17 transitions to a state 5. If the written-flag address register 14 is not set, the register state machine 17 remains in the state 4. If the written-flag bit register 15 is set in the state 5, the register state machine 17 transitions to a state 6. If the written-flag bit register 15 is not set, the register state machine 17 remains in the state 5.

The written-flag check command register 16 does not accept writing from the system bus 7 until the register state machine 17 comes to the state 6. When a command to execute a state check of the written flag F is set in the written-flag check command register 16, the written-flag check command register 16 transmits this command to the write/read signal issuing section 30. The write/read signal issuing section 30 reads data at an address set in the written-flag address register 14 from the nonvolatile memory 6. The command analyzing section 20 holds, as a written flag F, the value of a bit shown by the written-flag bit register 15 in the data that has been read out.

The foregoing processing, i.e., the processing in which the register state machine 17 transitions from the state 1 to the state 6 and the written-flag check command is issued so that the command analyzing section 20 holds the written flag F, is achieved by the execution of the system initialization program stored in the boot ROM 4 by the CPU 2. Until the entire processing is completed, the command analyzing section 20 prohibits any writing and erasing to the nonvolatile memory 6 through the system bus 7.

After the written flag F has been checked, the command analyzing section 20 determines whether to permit or prohibit writing/erasing. Specifically, if the written flag F indicates permission for writing (F=1), the command analyzing section 20 permits writing to the unrewritable area in the nonvolatile memory 6 indicated by the unrewritable-area address register 11 and the unrewritable-area address mask register 12, permits erasing to a sector set by the unrewritable-sector address register 13, and also permits erasing to all the areas in the nonvolatile memory 6. Accordingly, a system creator can freely write information which needs protection against tampering into the unrewritable area until the written flag F in the nonvolatile memory 6 is rewritten to “0” by the creator himself/herself. On the other hand, after the written flag F in the nonvolatile memory 6 has been rewritten to “0” by the system creator, the command analyzing section 20 permits neither writing nor erasing to the unrewritable area. Suppose the command analyzing section 20 always holds a copy of the written flag F in the nonvolatile memory 6, the number of times the written-flag check command is issued can be reduced.

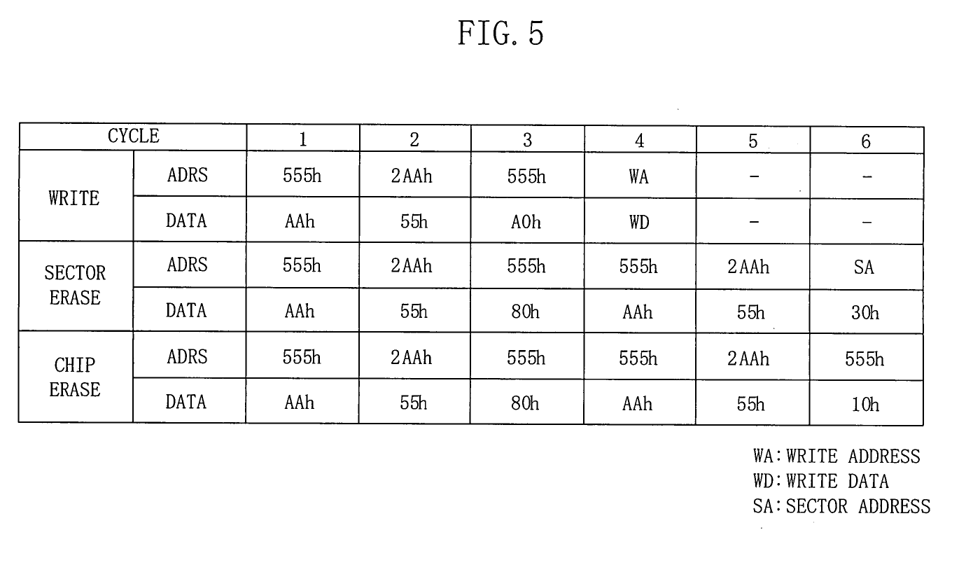

FIG. 5 shows an example of commands for the nonvolatile memory 6 shown in FIG. 1. The nonvolatile memory 6 is a flash memory which requires special command lines for wiring and erasing, respectively. In FIG. 5, ADRS is an address issued by the CPU 2 and DATA is data issued by the CPU 2.

As shown in the top row of the table shown in FIG. 5, in write commands, it is determined that if address 555h/data AAh, address 2AAh/data 55h and address 555h/data A0h are input at the first, second and third cycles, respectively, data WD input at the fourth cycle is written at address WA input at the fourth cycle.

As shown in the middle row of the table shown in FIG. 5, in sector erase commands, it is determined that if address 555h/data AAh, address 2AAh/data 5h, address 555h/data 80h, address 555h/data AAh, address 2AAh/data 55h and data 30h are input at the first, second, third, fourth, fifth and sixth cycles, respectively, erasing is performed in a sector specified by address SA which is input together with data 30h at the sixth cycle.

As shown in the bottom row of the table shown in FIG. 5, in chip erase commands, it is determined that the processing on and before the fifth cycle is the same as in the sector erase commands, and if address 555h/data 10h are input at the sixth cycle, erasing is performed in all the areas in the nonvolatile memory 6.

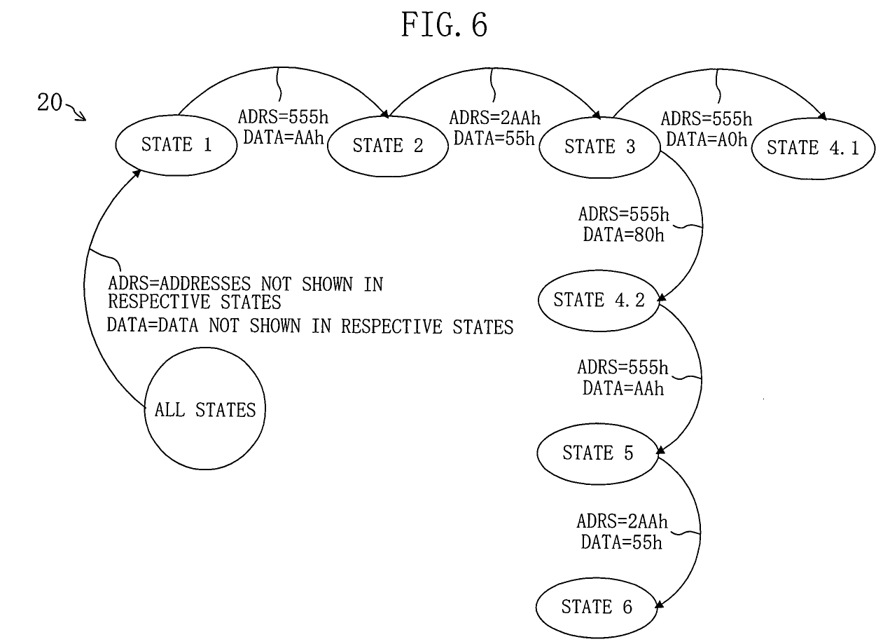

FIG. 6 shows operation of the command analyzing section 20 shown in FIG. 3. The command analyzing section 20 is in a state 1 as an initial state. If address 555h/data AAh are input from the system bus 7 in the state 1, the command analyzing section 20 transitions to a state 2. If the other inputs are made, the command analyzing section 20 remains in the state 1. If the address 2AAh/data 55h are input in the state 2, the command analyzing section 20 transitions to a state 3. If the other inputs are made, the command analyzing section 20 transitions to the state 1.

If address 555h/data A0h are input in state 3, the command analyzing section 20 transitions to a state 4.1. The state 4.1 is a state in which a normal write command is input from the system bus 7. In the state 4.1, the command analyzing section 20 determines whether or not the address WA input next to the normal write command is in the unrewritable area in the nonvolatile memory 6 set by the unrewritable-area address register 11 and the unrewritable-area address mask register 12. If the address is in the unrewritable area, no wiring is performed at this address. If the address is not in the unrewritable area, the data WD is written at this address.

If address 555h/data 80h are input in the state 3, the command analyzing section 20 transitions to a state 4.2. If the other inputs are made, the command analyzing section 20 transitions to the state 1. If the address 555h/data AAh are input in the state 4.2, the command analyzing section 20 transitions to a state 5. If the other inputs are made, the command analyzing section 20 transitions to the state 1. If the address 2AAh/data 55h are input in the state 5, the command analyzing section 20 transitions to a state 6. If the other inputs are made, the command analyzing section 20 transitions to the state 1.

Inputting address 555h/data 10h in the state 6 represents chip erasing. As long as the written flag F in the nonvolatile memory 6 indicates permission for rewriting (F=1), the command analyzing section 20 issues a chip erase command to the nonvolatile memory 6. On the other hand, after the written flag F in the nonvolatile memory 6 has been rewritten to “0”, chip erasing in the nonvolatile memory 6 is prohibited so that the command analyzing section 20 does not issue the erase command to the nonvolatile memory 6.

Inputting data 30h in the state 6 represents sector erasing. Accordingly, if the sector address SA input with the data 30h is different from a sector address set in the unrewritable-sector address register 13, the command analyzing section 20 issues a sector erase command associated with this address to the nonvolatile memory 6. If the sector address SA is the same as the sector address set in the unrewritable-sector address register 13, erasing to this sector is prohibited, so that the command analyzing section 20 does not issue a command to the nonvolatile memory 6. If the other inputs are made in the state 6, the command analyzing section 20 transitions to the state 1.

After confirming that all the command have been normally input and an address at which data is to be written by the CPU 2 or a sector address at which data is to be erased by the CPU 2 is not in the unrewritable area, the command analyzing section 20 sequentially supplies, to the write/read signal issuing section 30, all the commands that have been held from the command that was held first. Therefore, only the commands that are permitted to access are input to the write/read issuing section 30, so that the write/read signal issuing section 30 outputs all the addresses/data input from the command analyzing section 20 to the nonvolatile memory 6 without change.

In this manner, the access control circuit 5 analyzes the addresses/data input from the system bus 7 and, only when the access thereof is permitted, wiring/erasing to the nonvolatile memory 6 is performed.

More specifically, the command analyzing section 20 analyzes all the commands received from the CPU 2. If a received command line indicates wiring or sector erasing to the nonvolatile memory 6, the writing or erasing is directed to the unrewritable area and the written flag F indicates prohibition of rewriting, the command analyzing section 20 does not transmit the command line received from the CPU 2 to the nonvolatile memory 6 at all. If the command line received from the CPU 2 indicates chip erasing to the nonvolatile memory 6 and the written flag F indicates prohibition of rewriting, the command analyzing section 20 does not transmit the command line received from the CPU 2 to the nonvolatile memory 6 at all.

If the register file 10 shown in FIG. 2 is configurable by replacing the program in the boot ROM 4 shown in FIG. 1, the unrewritable area in the nonvolatile memory 6 can be set arbitrarily depending on systems. For example, if 4000h is set in the unrewritable-area address register 11 and 3FFFh is set in the unrewritable-area address mask register 12, the area from address 4000h to 7FFFh is set as the unrewritable area.

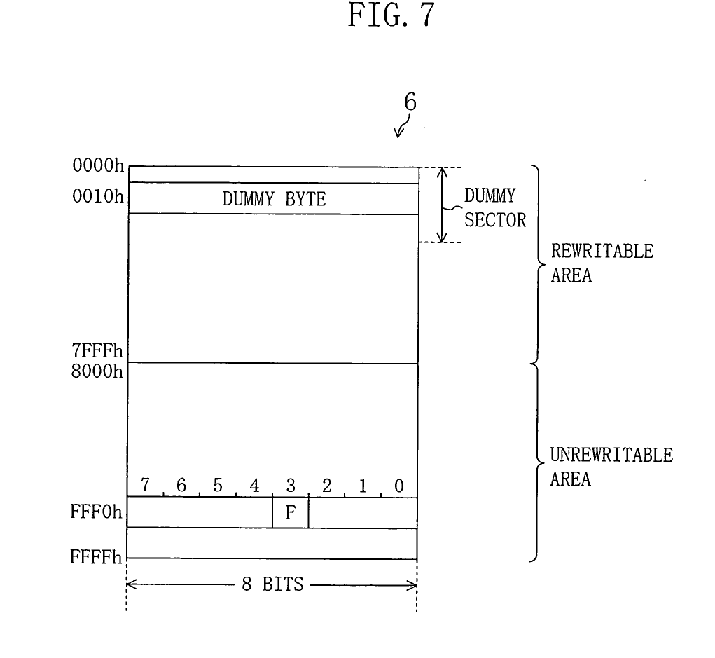

FIG. 7 shows another inside configuration of the nonvolatile memory 6 shown in FIG. 1. In FIG. 7, a dummy sector is provided in the nonvolatile memory 6 as an unused area in which no useful data is placed. For example, address 0010h is defined as a dummy byte.

In this case, if the command line received from the CPU 2 indicates wiring to the nonvolatile memory 6, the writing is directed to the unrewritable area and the written flag F indicates prohibition of rewriting, the command analyzing section 20 operates such that data is written to the dummy byte. If the command line received from the CPU 2 indicates sector erasing to the nonvolatile memory 6, the erasing is directed to the unrewritable area, and the written flag F indicates prohibition of rewriting, the command analyzing section 20 operates such that data is written to the dummy sector. If the command line received from the CPU 2 indicates chip erasing to the nonvolatile memory 6 and the written flag F indicates prohibition of rewriting, the command analyzing section 20 operates such that data is also written to the dummy sector.

As described above, every time an address/data shown in FIG. 5 are input from the system bus 7, the command analyzing section 20 outputs the address/data to the write/read signal issuing section 30 without changing the address to which wiring/erasing is directed in the case of writing/erasing to the rewritable area, while outputting the address/data with changing the address to which writing/erasing is directed in the case of writing/erasing to the unrewritable area, thereby completing the writing/erasing sequence. That is, with only part of the writable area sacrificed, the access speed to the nonvolatile memory 6 is enhanced as compared to the case of FIG. 2 in which the command analyzing section 20 temporarily holds a command line.

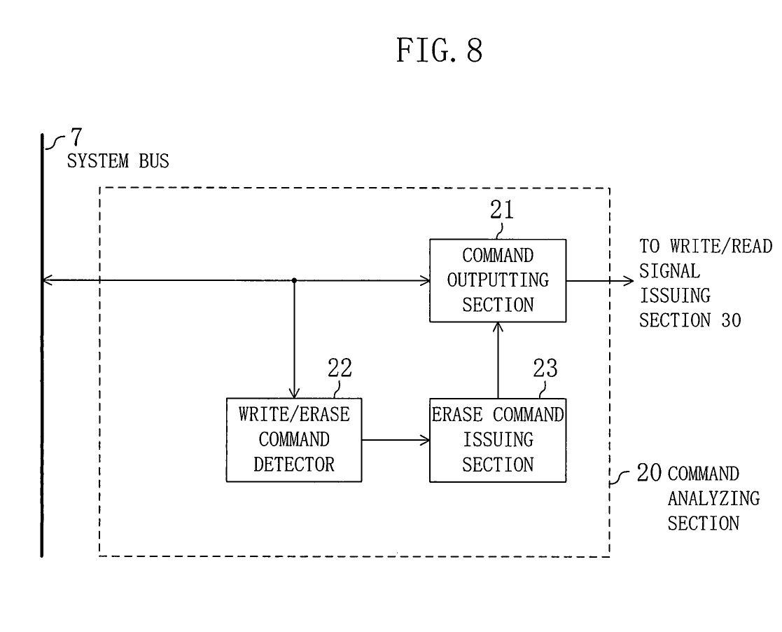

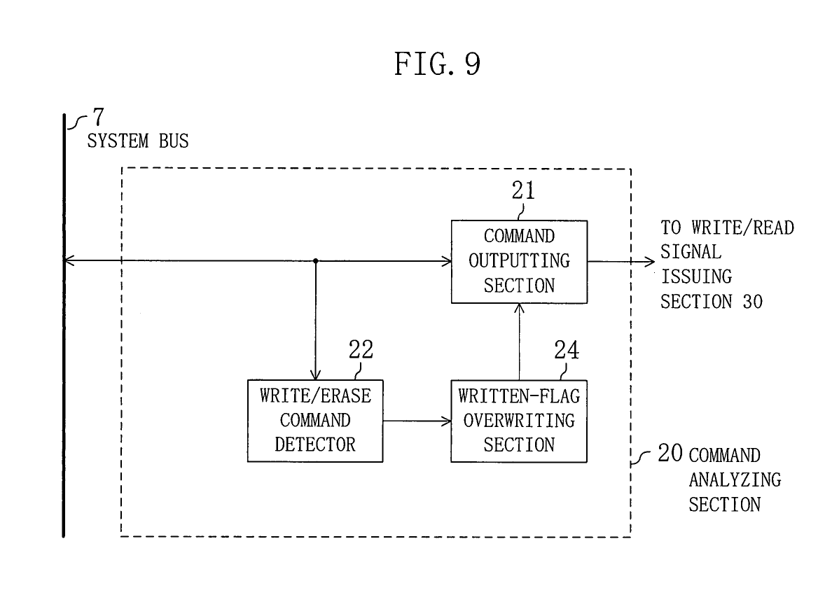

Lastly, configurations capable of imposing a penalty on a person who tries to tamper with information in the unrewritable area will be described with reference to FIGS. 8 and 9.

FIG. 8 is a diagram showing an inside configuration of the command analyzing section 20 shown in FIG. 3. In FIG. 8, reference numeral 21 denotes a command outputting section, reference numeral 22 denotes a write/erase command detector 22, and reference numeral 23 denotes an erase command issuing section. The command outputting section 21 generally supplies a command received from the CPU 2 via the system bus 7 to the write/read signal issuing section 30 without change. The write/erase command detector 22 detects a write/erase command to the unrewritable area and, if the written flag F indicates prohibition of rewriting (F=0), notifies the erase command issuing section 23 of this indication. In response to this, the erase command issuing section 23 gives, to the command outputting section 21, an instruction to issue erase commands to all the sectors other than a sector address set in the unrewritable-sector address register 13 shown in FIG. 3. Then, the command outputting section 21 issues sector erase commands in accordance with the instruction. This enables protection against tampering and also enables erasing useful information in the rewritable area so as to impose a penalty on a person who tries to tamper.

FIG. 9 is a diagram showing another inside configuration of the command analyzing section 20 shown in FIG. 3. In FIG. 9, the erase command issuing section 23 shown in FIG. 8 is replaced with a written-flag overwriting section 24. This written-flag overwriting section 24 detects a write/erase command to the unrewritable area and, if notified by the write/erase command detector 22 that the written flag F indicates prohibition of rewriting (F=0), gives an entire-area write instruction to the command outputting section 21 such that the same value as the written flag F (=0) acquired by executing the state confirmation based on the written-flag check command register 16 shown in FIG. 3 is used as write data. The command outputting section 21 issues an entire-area write command in accordance with the instruction. In this manner, all the data in the nonvolatile memory 6 is rewritten to the same value as the written flag F (=0). In addition, since the written flag F itself still indicates prohibition of rewriting (F=0), subsequent writing is not accepted either.

If all the bits are “0” in the initial state of the nonvolatile memory 6, it is determined that “F=0” indicates permission for rewriting and “F=1” indicates prohibition of rewriting.

The present invention is also applicable to other types of nonvolatile memories such as an EEPROM (Electrically Erasable and Programmable Read Only Memory).

What is claimed is:

1. An access control system for a nonvolatile memory, the system comprising:
a nonvolatile memory;
a boot ROM (Read Only Memory) in which a program for initializing the system is stored;
a CPU (Central Processing Unit) for issuing a command to the nonvolatile memory; and
an access control circuit for receiving the command from the CPU and controlling access to the nonvolatile memory,
wherein at every power-on of the system, the CPU executes the program for initializing the system stored in the boot ROM so that an unrewritable area is set at only one time in the nonvolatile memory and a written flag is set at only one time in the unrewritable area, and
the access control circuit prohibits writing to the nonvolatile memory before checking the state of the written flag and, after checking the state of the written flag, the access control circuit permits writing to the unrewritable area at any number of times as long as the written flag does not indicate prohibition of rewriting, while prohibiting writing to the unrewritable area after prohibition of rewriting has been set in the written flag.

2. The access control system of claim 1, wherein the access control circuit includes a command analyzing section for analyzing the command received from the CPU, and
the command analyzing section does not transmit the command received from the CPU to the nonvolatile memory if the command received from the CPU indicates writing or erasing to the nonvolatile memory, the writing or erasing is directed to the unrewritable area in the nonvolatile memory and the written flag indicates prohibition of rewriting.

3. The access control system of claim 2, wherein if a special command line is needed for writing or erasing to the nonvolatile memory, the command analyzing section analyzes all the commands received from the CPU, and if the command line indicates writing or erasing to the nonvolatile memory, the writing or erasing is directed to the unrewritable area in the nonvolatile memory and the written flag indicates prohibition of rewriting, the command analyzing section does not transmit a command line received from the CPU to the nonvolatile memory at all.

4. The access control system of claim 2, wherein if a special command line is needed for erasing all the data in the nonvolatile memory, the command analyzing section analyzes all the commands received from the CPU, and if the command line indicates erasing all the data in the nonvolatile memory and the written flag indicates prohibition of rewriting, the command analyzing section does not transmit a command line received from the CPU to the nonvolatile memory at all.

5. The access control system of claim 1, wherein an unused area in which no useful data is placed is provided in the nonvolatile memory,
the access control circuit includes a command analyzing section for analyzing the command received from the CPU, and
the command analyzing section operates such that writing or erasing is performed in the unused area in the nonvolatile memory if the command received from the CPU indicates writing or erasing to the nonvolatile memory, the writing or erasing is directed to the unrewritable area in the nonvolatile memory and the written flag indicates prohibition of rewriting.

6. The access control system of claim 5, wherein if a special command line is needed for writing or erasing to the nonvolatile memory, the command analyzing section analyzes all the commands received from the CPU, and if the command line indicates writing or erasing to the nonvolatile memory, the writing or erasing is directed to the unrewritable area in the nonvolatile memory and the written flag indicates prohibition of rewriting, the command analyzing section operates such that writing or erasing is performed in the unused area in the nonvolatile memory.

7. The access control system of claim 5, wherein if a special command line is needed for erasing all the data in the nonvolatile memory, the command analyzing section analyzes all the commands received from the CPU, and if the command line indicates erasing all the data in the nonvolatile memory and the written flag indicates prohibition of rewriting, the command analyzing section operates such that all the data in the unused area in the nonvolatile memory is erased.

8. The access control system of claim 1, wherein the access control circuit detects writing or erasing to the unrewritable area in the nonvolatile memory and, if the written flag indicates prohibition of rewriting, erases data in the area except for the unrewritable area in the nonvolatile memory.

9. The access control system of claim 1, wherein the access control circuit detects writing or erasing to the unrewritable area in the nonvolatile memory and, if the written flag indicates prohibition of rewriting, rewrites all the data in the nonvolatile memory such that the data have the same value as the written flag.
